(19) United States
(12) Patent Application Publication
(10) Pub. No.: US 2017/0026976 A1
(43) Pub. Date: Jan. 26, 2017

(54) FLEXIBLE CODING SCHEMES

(71) Applicant: QUALCOMM Incorporated, San Diego, CA (US)

(72) Inventors: Taesang Yoo, Riverside, CA (US); Jing Sun, San Diego, CA (US); Durga Prasad Malladi, San Diego, CA (US); Yongbin Wei, La Jolla, CA (US); Weiliang Zeng, San Diego, CA (US); Siddhartha Mallik, San Diego, CA (US); Aleksandar Damnjanovic, Del Mar, CA (US)

(21) Appl. No.: 15/175,966

(22) Filed: Jun. 7, 2016

Related U.S. Application Data
(60) Provisional application No. 62/194,687, filed on Jul. 20, 2015.

(51) Int. Cl. H04W 72/08; H04L 1/00; H04W 72/04

(52) U.S. Cl. CPC H04W 72/082; H04W 72/042; H04W 72/0413; H04L 1/0057

(57) ABSTRACT

Methods, systems, and devices for wireless communication using various coding schemes for data transmission are described. A wireless communication system may support multiple coding schemes such as, for example, turbo codes and low density parity check codes. The system may support selection of the coding scheme based on explicit signaling or implicit evaluation of transmission parameters. A transmitting device may select a coding scheme, encode a message using the selected coding scheme, and transmit the encoded message over a wireless connection. The receiving device may receive the encoded message, select the coding scheme, and decode the message using the select coding scheme.

### CROSS REFERENCES

The present application for patent claims priority to U.S. Provisional Patent Application No. 62/194,687 by Yoo et al., entitled “Flexible Coding Schemes,” filed Jul. 20, 2015, assigned to the assignee hereof.

### BACKGROUND

The following relates generally to wireless communication, and more specifically to flexible coding schemes.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is designed to improve spectral efficiency, lower costs, improve services, make use of new spectrum, and better integrate with other open standards. LTE may use OFDMA on the downlink (DL), single-carrier frequency division multiple access (SC-FDMA) on the uplink (UL), and multiple-input multiple-output (MIMO) antenna technology. A wireless multiple-access communications system (including an LTE system) may include a number of base stations, each supporting communication for multiple communication devices, which may be otherwise known as user equipment (UE).

Some wireless systems may support communication using coding schemes, which may enable forward error correction for wireless data transmissions. The coding schemes may include turbo codes and low density parity check (LDPC) codes. Different coding schemes may have different characteristics, including differences in spectral efficiency and computational complexity.

### SUMMARY

A wireless communication system may support multiple coding schemes such as, for example, turbo codes (TC) and low density parity check (LDPC) codes. The system may support selection of a coding scheme based on explicit signaling or implicit evaluation of transmission parameters. A transmitting device may select a coding scheme, encode a message using the selected coding scheme, and transmit the encoded message over the wireless connection. The receiving device may receive the encoded message, identify the coding scheme, and decode the message using the selected coding scheme.

A method of wireless communication is described. The method may include selecting a coding scheme from a plurality of coding schemes available for a wireless connection, encoding a message using the selected coding scheme, and transmitting the encoded message over the wireless connection.

An apparatus for wireless communication is described. The apparatus may include means for selecting a coding scheme from a plurality of coding schemes available for a wireless connection, means for encoding a message using the selected coding scheme, and means for transmitting the encoded message over the wireless connection.

A further apparatus for wireless communication is described. The apparatus may include a processor, memory in electronic communication with the processor, and instructions stored in the memory and executable by the processor, to cause the apparatus to select a coding scheme from a plurality of coding schemes available for a wireless connection, encode a message using the selected coding scheme, and transmit the encoded message over the wireless connection.

A non-transitory computer-readable medium storing code for wireless communication is described. The code may include instructions executable to select a coding scheme from a plurality of coding schemes available for a wireless connection, encode a message using the selected coding scheme, and transmit the encoded message over the wireless connection.

Some examples of the method, apparatuses, or non-transitory computer-readable medium described herein may further include processes, features, means, or instructions for transmitting an indication of the coding scheme to a user equipment, wherein the encoded message is a downlink message. Additionally or alternatively, in some examples the indication of the coding scheme comprises a semi-static indication or a dynamic indication.

Some examples of the method, apparatuses, or non-transitory computer-readable medium described herein may further include processes, features, means, or instructions for receiving an indication of the coding scheme from a base station, wherein the message is an uplink message. Additionally or alternatively, in some examples the indication of the coding scheme comprises a semi-static indication or a dynamic indication.

Some examples of the method, apparatuses, or non-transitory computer-readable medium described herein may further include processes, features, means, or instructions for determining a transmission parameter for the encoded message, wherein selecting the coding scheme is based at least in part on the transmission parameter. Additionally or alternatively, in some examples the transmission parameter comprises a data rate, a decoding latency budget a device capability, or a combination thereof.

In some examples of the method, apparatuses, or non-transitory computer-readable medium described herein, the coding scheme is selected based at least in part on the wireless connection using a contention based spectrum. Additionally or alternatively, in some examples the plurality of coding schemes comprises at least a turbo coding scheme and a low density parity check coding scheme. The selected coding scheme may include the turbo coding scheme for a first portion of a transmission time interval and the low density parity check coding scheme for a second portion of the transmission time interval.

A method of wireless communication is described. The method may include selecting a coding scheme from a plurality of coding schemes available for a wireless connection, the plurality of coding schemes comprising at least a turbo coding scheme and a low density parity check coding scheme, receiving a message over the wireless connection, and decoding the message using the selected coding scheme.

An apparatus for wireless communication is described. The apparatus may include means for selecting a coding scheme from a plurality of coding schemes available for a connection, the plurality of coding schemes comprising at least a turbo coding scheme and a low density parity check coding scheme, means for receiving a message over the wireless connection, and means for decoding the message using the selected coding scheme.

A further apparatus for wireless communication is described. The apparatus may include a processor, memory in electronic communication with the processor, and instructions stored in the memory and executable by the processor to cause the apparatus to select a coding scheme from a plurality of coding schemes available for a connection, the plurality of coding schemes comprising at least a turbo coding scheme and a low density parity check coding scheme, receive a message over the wireless connection, and decode the message using the selected coding scheme.

A non-transitory computer-readable medium storing code for wireless communication is described. The code may include instructions executable to select a coding scheme from a plurality of coding schemes available for a connection, the plurality of coding schemes comprising at least a turbo coding scheme and a low density parity check coding scheme, receive a message over the wireless connection, and decode the message using the selected coding scheme.

Some examples of the method, apparatuses, or non-transitory computer-readable medium described herein may further include processes, features, means, or instructions for transmitting an indication of the coding scheme to a user equipment, wherein the message is an uplink message. Additionally or alternatively, in some examples the indication of the coding scheme comprises a semi-static indication or a dynamic indication.

Some examples of the method, apparatuses, or non-transitory computer-readable medium described herein may further include processes, features, means, or instructions for receiving an indication of the coding scheme from a base station, wherein the message is a downlink message. Additionally or alternatively, in some examples the indication of the coding scheme comprises a semi-static indication or a dynamic indication.

Some examples of the method, apparatuses, or non-transitory computer-readable medium described herein may further include processes, features, means, or instructions for determining a transmission parameter for the message, wherein selecting the coding scheme is based at least in part on the transmission parameter. Additionally or alternatively, in some examples the transmission parameter comprises a data rate, a decoding latency budget, a device capability, or a combination thereof.

In some examples of the method, apparatuses, or non-transitory computer-readable medium described herein, the coding scheme is selected based at least in part on the wireless connection using contention based spectrum. Additionally or alternatively, in some examples the selected coding scheme comprises at least a turbo coding scheme and a low density parity check coding scheme. The selected coding scheme may include the turbo coding scheme for a first portion of a transmission time interval and the low density parity check coding scheme for a second portion of the transmission time interval.

### BRIEF DESCRIPTION OF THE DRAWINGS

Aspects of the disclosure are described in reference to the following figures:

FIG. 1 illustrates an example of a wireless communications system that supports flexible coding schemes in accordance with various aspects of the present disclosure;

FIG. 2 illustrates an example of a wireless communications system that supports flexible coding schemes in accordance with various aspects of the present disclosure;

FIG. 3 illustrates an example of a process flow that supports flexible coding schemes in accordance with various aspects of the present disclosure;

FIGS. 4-6 show block diagrams of a wireless device that supports flexible coding schemes in accordance with various aspects of the present disclosure;

FIG. 7 illustrates a block diagram of a system including a device that supports flexible coding schemes in accordance with various aspects of the present disclosure;

FIG. 8 illustrates a block diagram of a system including a base station that supports flexible coding schemes in accordance with various aspects of the present disclosure; and

FIGS. 9-16 illustrate methods for flexible coding schemes in accordance with various aspects of the present disclosure.

### DETAILED DESCRIPTION

Some wireless systems may apply forward error correction (FEC) to reduce or correct errors in data transmissions using coding schemes such as Turbo Codes (TC) and Low Density Parity Check (LDPC) codes. For example, some wireless wide area networks (WWANs) (e.g., LTE and other types of cellular networks) use TC to achieve a high spectral efficiency. By contrast, many wireless local area networks (WLANs), (e.g., WiFi) use LDPC to meet tight decoding latency specifications at lower computational cost. Additional coding schemes used for FEC in wireless communications include, for example, polar codes, Reed-Solomon codes, Reed-Muller codes, and convolutional codes.

While different types of wireless communications systems are conventionally associated with static coding schemes for FEC, in some cases a multi-mode wireless device may include hardware supporting multiple coding methods for FEC. For example, a wireless device may include an LTE modem having a TC encoder/decoder and a WLAN modem having a LDPC encoder/decoder. In these cases, the modems may be interoperable such that either coding scheme can be used to implement FEC for either modem. This capability may enable dynamic toggling of coding schemes to accommodate different types of wireless transmissions, which may increase the overall performance and efficiency of the wireless device. Accordingly, this disclosure outlines techniques and selection criteria by which a coding scheme may be identified and selected for a given wireless connection.

The selection and use of a coding scheme for the wireless connection may occur implicitly or through signaling over the connection. The implicit selection of a coding scheme may be based on a data rate of the data transmission, a decoding latency budget, a user equipment (UE) or base station capability, or a combination thereof. When signaling is used to communicate the selection of a coding scheme, one wireless device may select the coding scheme and then indicate that selection to one or more other wireless devices associated with the connection in a downlink (DL) or uplink (UL) grant or other message.

Aspects of the disclosure are initially described in the context of a wireless communication system. Specific examples are then described for selecting a coding scheme from a set of coding schemes available for a wireless connection, encoding a message using the selected coding scheme, transmitting the encoded message over the wireless connection, and decoding the message using the selected coding scheme. These and other aspects of the disclosure are further illustrated by and described with reference to apparatus diagrams, system diagrams, and flowcharts that relate to flexible coding schemes.

As used in this description and the appended claims, the term “coding scheme” refers to an algorithm or process by which data bits are encoded with redundant data at the physical layer for forward error correction in a wireless transmission.

As used in this description and the appended claims, the term “semi-static indication” refers to a) a message signaling a selection of a coding scheme that remains in force until the selection is modified by a subsequent transmitted message or b) a message signaling rules for selecting a coding scheme wherein the rule remains in force until modified by a subsequent transmitted message.

As used in this description and the appended claims, the term “dynamic indication” refers to a message signaling a selection of a coding scheme specific to an instantaneous transmission or set of transmissions or associated with an expiration.

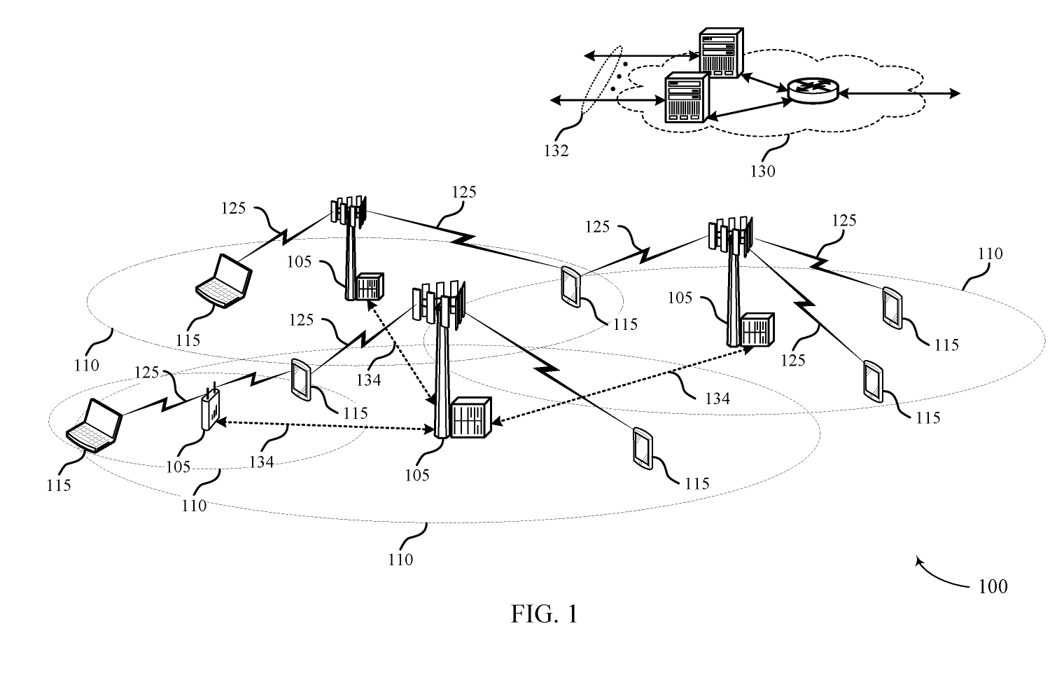

FIG. 1 illustrates an example of a wireless communications system 100 in accordance with various aspects of the present disclosure. The wireless communications system 100 includes base stations 105, user equipment (UEs) 115, and a core network 130. In some examples, the wireless communications system 100 may be a Long Term Evolution (LTE)/LTE-advanced (LTE-A) network. Wireless communications system 100 may support dynamic selection of different coding schemes such as TC or LDPC coding schemes.

Base stations 105 may wirelessly communicate with UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions from a base station 105 to a UE 115. UEs 115 may be dispersed throughout the wireless communications system 100, and each UE 115 may be stationary or mobile. A UE 115 may also be referred to as a station (STA), a mobile station, a subscriber station, a remote unit, a wireless device, an access terminal, a handset, a user agent, a client, or some other suitable terminology. A UE 115 may be a cellular phone, a wireless modem, a handheld device, a personal computer, a tablet, a personal electronic device, a machine type communication (MTC) device or other wireless device.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

Wireless communications system 100 may employ one or more methods for improving the reliability of communications. These methods may include forward error correction (FEC) and hybrid automatic repeat request (HARQ). In some cases, FEC may use a data coding scheme such as a turbo code (TC), which may use a combination of data permutations and a convolutional code. In other cases, FEC may be based on a low density parity check (LDPC) code using a bipartite graph.

HARQ may be based on a combination of error detection (e.g., using a cyclic redundancy check (CRC)), forward error correction (FEC), and retransmission (e.g., automatic repeat request (ARQ)). HARQ may improve throughput at the medium access control (MAC) layer in poor radio conditions (e.g., signal-to-noise conditions). In HARQ, incorrectly received data (including systematic and redundancy bits) may be stored in a buffer and combined with subsequent transmissions to improve the overall likelihood of successfully decoding the data. In Incremental Redundancy (IR) HARQ, additional redundancy bits are added to subsequent transmission (i.e. retransmission), which, combined with the initial transmissions, effectively lowers the code rate and thus increases the chance of successful decoding. In chase combining (CC) HARQ, the same systematic and redundancy bits are transmitted at each retransmission, effectively increasing the signal-to-noise ratio at the receiver and thus increasing the chance of successful decoding. In HARQ, retransmissions are initiated after the transmitter of the original message receives a negative acknowledgement (NACK) indicating a failed attempt to decode the information. The chain of transmission, response and retransmission may be referred to as a HARQ process. In some examples, a limited number of HARQ processes may be used for a given communication link 125.

In some cases, a UE 115 or base station 105 may operate in a shared or unlicensed frequency spectrum. These devices may perform a clear channel assessment (CCA) prior to communicating in order to determine whether the channel is available. A CCA may include an energy detection procedure to determine whether there are any other active transmissions. For example, the device may infer that a change in a signal strength of a power meter indicates that a channel is occupied. Specifically, signal power is that is concentrated in a certain bandwidth and exceeds a predetermined noise floor may indicate another wireless transmitter. A CCA may also include detection of specific sequences that indicate use of the channel. For example, another device may transmit a specific preamble prior to transmitting a data sequence. In some cases, wireless communications system 100 may support the use of different coding schemes, or combinations of coding schemes for unlicensed spectrum.

In some cases, wireless communications system 100 may utilize one or more enhanced component carriers (eCCs). An enhanced component carrier (eCC) may be characterized by one or more features in comparison to other types of component carriers including: flexible bandwidth, different transmission time interval (TTIs), and modified control channel configuration. In some cases, an eCC may be associated with a carrier aggregation (CA) configuration or a dual connectivity configuration (e.g., when multiple serving cells have a suboptimal backhaul link). An eCC may also be configured for use in unlicensed spectrum or shared spectrum (e.g., where more than one operator is licensed to use the spectrum). An eCC characterized by flexible bandwidth may include one or more segments that may be utilized by UEs 115 that do are not capable of monitoring the whole bandwidth or prefer to use a limited bandwidth (e.g., to conserve power).

In some cases, an eCC may use a different TTI length than other component carriers (CCs), which may include use of a reduced or variable symbol duration as compared with TTIs of the other CCs. The symbol duration may remain the same, in some cases, but each symbol may represent a distinct TTI. In some examples, an eCC may include multiple hierarchical layers associated with the different TTI lengths. For example, TTIs at one hierarchical layer may correspond to uniform 1 ms subframes, whereas in a second layer, variable length TTIs may correspond to bursts of short duration symbol periods. In some cases, a shorter symbol duration may also be associated with increased subcarrier spacing. In conjunction with the reduced TTI length, an eCC may utilize dynamic time division duplex (TDD) operation (i.e., it may switch from downlink (DL) to uplink (UL) operation for short bursts according to dynamic conditions.)

Flexible bandwidth and variable TTIs may be associated with a modified control channel configuration (e.g., an eCC may utilize an enhanced physical downlink control channel (ePDCCH) for DL control information). For example, one or more control channels of an eCC may utilize frequency-division multiplexing (FDM) scheduling to accommodate flexible bandwidth use. Other control channel modifications include the use of additional control channels (e.g., for evolved multimedia broadcast multicast service (eMBMS) scheduling, or to indicate the length of variable length UL and DL bursts), or control channels transmitted at different intervals. An eCC may also include modified or additional HARQ related control information.

In some cases, an eCC of a cellular network may be implemented over a channel in an unlicensed radio spectrum or other contention-based shared spectrum. The unlicensed or shared spectrum may be shared among various radio access technologies, including one or more wireless local area networks (WLANs). The different radio access technologies may contend with each other for access to the spectrum using a listen-before-talk structure. Some wireless devices may be capable of using multiple radio access technologies over the same spectrum. For example, a UE 115 or base station 105 may have both a cellular modem and a WLAN modem, both of which may operate over the same band of unlicensed spectrum. The cellular modem may use a turbo code (TC) encoder/decoder and the WLAN modem may use a low density parity check (LDPC) encoder/decoder. In some cases, both encoder/decoders may be available to either modem.

Thus, certain base stations 105 and UEs 115 of wireless communications system 100 may support multiple coding schemes such as TCs and LDPC codes. Selection of the coding scheme may be based on explicit signaling or implicit evaluation of transmission parameters. A transmitting device (UE 115 or base station 105) may select a coding scheme, encode a message using the selected coding scheme, and transmit the encoded message over the wireless connection. The receiving device (UE 115 or base station 105) may identify the coding scheme, receive the encoded message over the wireless connection, and decode the message using the selected coding scheme.

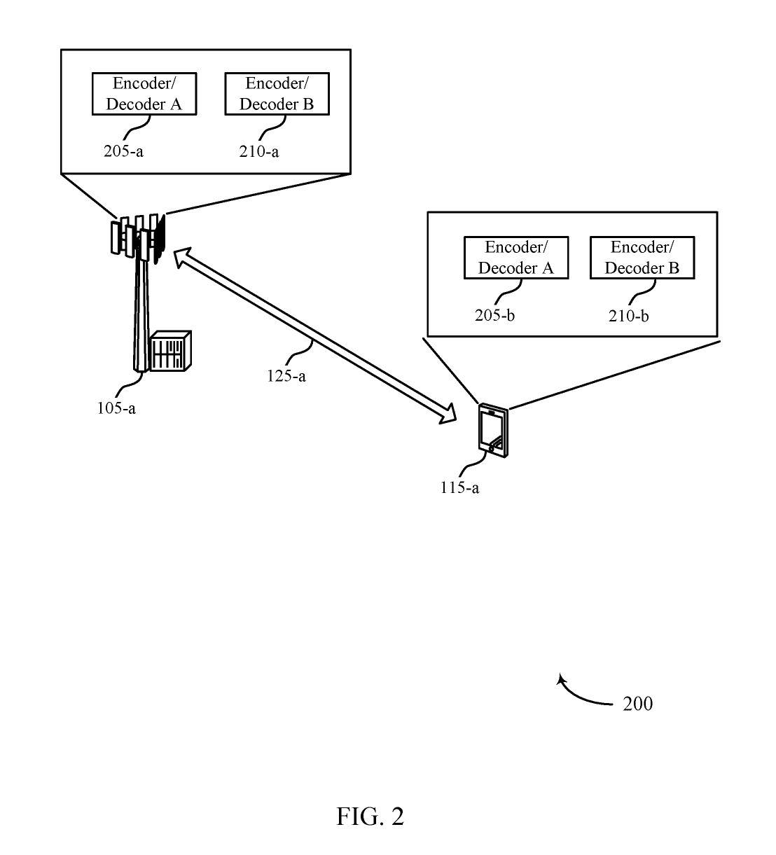

FIG. 2 illustrates an example of a wireless communications system 200 for flexible coding schemes in accordance with various aspects of the present disclosure. Wireless communications system 200 may include a UE 115-a and base station 105-a, which may be respective examples of a UE 115 base station 105 described with reference to FIG. 1. UE 115-a and base station 105-a may each have a first encoder/decoder 205-a, 205-b implementing a first coding scheme and a second encoder/decoder 210-b, 210-b implementing a second encoding scheme. Base station 105-a may transmit data using either the first encoding scheme or the second encoding scheme, and configure UE 115-a to transmit and decode data using either the first encoding scheme or the second encoding scheme. While the remainder of FIG. 2 is described using the example of TC and LDPC as the first and second encoding schemes, it will be apparent to those skilled in the art that other types of coding schemes may be used in addition to or in place of TC and LDPC. Examples of other coding schemes include polar coding schemes, convolutional coding schemes, and the like.

In some cases, TC may support a higher spectral efficiency than LDPC, and LDPC may be implemented at a lower cost and lower latency than TC. Thus, in an unlicensed frequency spectrum (e.g., a contention based frequency spectrum), it may be appropriate to include flexible use of TC and LDPC. This flexibility may allow reuse of TC and LDPC without exceeding capability or adding hardware. Using multiple encoders/decoders such as encoders/decoders 205 and 210 may support flexible use of TC and LDPC.

In some cases, it may be appropriate to select the coding scheme based on one or more transmission parameters associated with a communication link 125-a between UE 115-a and base station 105-a. For example, the transmission parameter may be correlated with throughput or latency such that TC is selected for lower throughput or higher-latency data connections and LDPC is selected for higher throughput and lower latency data connections.

Examples of possible transmission parameters include: data rate (e.g., connections having a nominal data rate that is higher than a predefined threshold use LDPC and having a nominal data rate that is lower than the predefined threshold use TC), channel bandwidth (e.g., connections over a channel bandwidth that is higher than a predefined threshold use LDPC and connections over a channel bandwidth that is lower than the predefined threshold use TC), modulation and coding scheme (MCS) (e.g., connections with an MCS index that is higher than a predefined threshold use LDPC and connections with an MCS index that is lower than the predefined threshold use TC), transmission rank (e.g., connections with a transmission rank that is higher than a predefined threshold use LDPC and connections with a transmission rank that is lower than the predefined threshold use TC), decoding or ACK/NACK timing budgets (e.g., connections with budgets that are higher than a predefined threshold use TC, and connections with lower budgets than the predefined threshold use LDPC).

The coding scheme may be selected based on the receiver's decoder capability, in particular, the decoder throughput (i.e. how many bits the decoder can decode at a given time). In some examples, UE 115-a may signal an indication of its decoder throughput to base station 105-a, and base station 105-a may select the coding scheme and signal the selected coding scheme back to UE 115-a.

The selection of thresholds for the above-referenced transmission parameters may be implementation-specific based on device capabilities, resource availability, and field conditions. Some examples may use a combination of thresholds for different transmission parameters to select an appropriate coding scheme. In one example, TC may be used for data connections over a 20 MHz channel bandwidth or over an 80 MHz bandwidth with low MCS indices (e.g., below a predefined threshold). In this example, LDPC may be used for data connections over the 80 MHz channel bandwidth with high MCS indices (e.g. at or above the predefined threshold).

Additionally, TC may be used in conjunction with incremental redundancy (IR), chase combining (CC), or ARQ, and LDPC may be used in conjunction with CC or ARQ but not IR. In some cases, TC and LDPC may be mixed in one transmission time interval (TTI). For example, the turbo coding scheme may be used for a first portion of a transmission time interval and the low density parity check coding scheme may be used for a second portion of the transmission time interval. Some codeblocks (CBs) and codewords (CWs) (e.g., spatial layers) may use TC and others may use LDPC. For example, one CW may have high MCS and use LDPC, and the other CW may have low MCS and use TC.

In wireless communications system 200, the selection of TC or LDPC for a connection may be determined independently by both the base station 105-a and UE 115-a using one or more of the above-referenced transmission parameters. Alternatively, one of the base station 105-a or UE 115-a may select the coding scheme and notify the other device of the selected coding scheme using explicit signaling. For example, an indication of whether to use TC or LDPC may be included in a downlink (DL) or uplink (UL) grant (e.g., a bit indicating either TC or LDPC). The selected coding scheme may be signaled dynamically or semi-statically. Additionally or alternatively, one of the devices may signal to the other device a set of dynamic, static, or semi-static selection criteria thresholds for use by the other device to independently select the appropriate coding scheme.

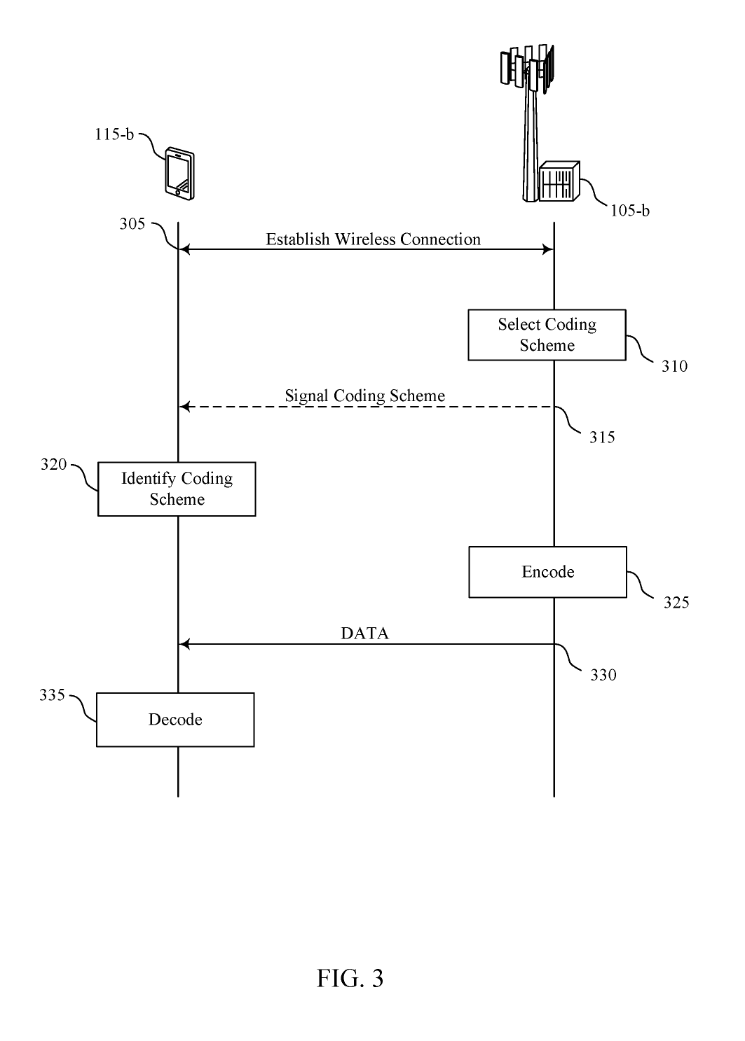

FIG. 3 illustrates an example of a process flow 300 for flexible coding schemes in accordance with various aspects of the present disclosure. Process flow 300 may include a UE 115-b and base station 105-b, which may be examples of a UE 115 and base station 105 described with reference to FIGS. 1-2. UE 115-b and base station 105-b may be configured for communication using multiple coding schemes. Although process flow 300 illustrates an example in which base station 105-b encodes messages and transmits to UE 115-b, either device could be the transmitting device or the receiving device.

At 305, base station 105-b and UE 115-b may establish a wireless connection. The wireless connection may be established over a contention-based or unlicensed frequency spectrum, and may include one or more eCCs. The wireless connection may support flexible use of multiple coding schemes, such as TC, LDPC, or other coding schemes.

At 310, base station 105-b may select a coding scheme from the set of coding schemes available for the wireless connection (e.g., a TC scheme and an LDPC coding scheme). The coding schemes available for the wireless connection may be defined by the hardware encoders installed in both the base station 105-b and the UE 115-b. In some cases, UE 115-b may signal its set of supported coding schemes to base station 105-b, and base station 105-b may determine the set of coding schemes available for the wireless connection as the set of coding schemes supported by both base station 105-b and UE 115-b.

The base station 105-b may identify a transmission parameter of a message to be transmitted to the UE and select the coding scheme based on the transmission parameter. The transmission parameter may include a data rate, a decoding latency budget or a device capability. Additionally, base station 105-b may select the coding scheme based on the wireless connection using a contention based (or unlicensed) spectrum.

At 315, base station 105-b may signal the selected coding scheme to UE 115-b. The signal may include a semi-static indication or a dynamic indication of the coding scheme. Upon receiving the coding scheme, UE 115-b may transmit a message (e.g., an uplink message) to base station 105-b using the coding scheme. UE 115-b may also use the coding scheme to decode data packets sent by base station 105-b.

In some cases, base station 105-b may not send an explicit signal. That is, in some cases, UE 115-b may implicitly determine the coding scheme used for transmitting and decoding. Implicit determination may be based on one or more transmission parameters or device constraints such as data rate, channel bandwidth, MCS, transmission rank, decoding or ACK/NACK timing budgets, or device capabilities, as described above with reference to FIG. 2.

At 320, UE 115-b may identify the coding scheme based on the one or more transmission parameters and their associated thresholds, as described above with reference to FIG. 2. In some cases the coding scheme is identified prior to the data transmission, but in other cases the transmission is received and aspects of the transmission may be used to identify the coding scheme.

At 325, base station 105-b may encode data using the selected coding scheme. At 330, base station 105-b may transmit the encoded message over the wireless connection. At 330, UE 115-b may decode the encoded message received from base station 105-b. UE 115-b may decode the message using the coding scheme (as signaled by base station 105-b or implicitly determined). It will be understood by those of skill in the art that the operations of blocks 325, 330, and 335 may be reversed such that the UE performs the encoding of block 325 and transmitting of block 330 and the BS performs the decoding of block 335.

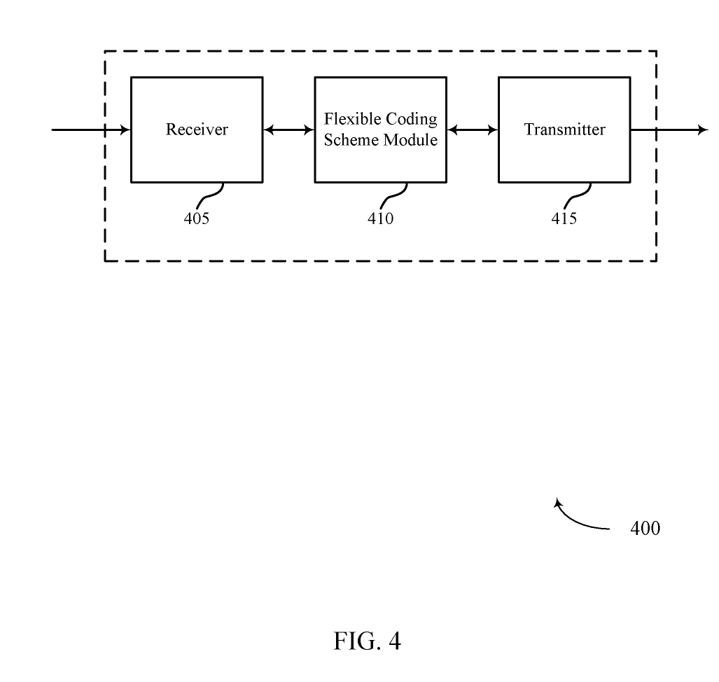

FIG. 4 shows a block diagram of a wireless device 400 configured for flexible coding schemes in accordance with various aspects of the present disclosure. Wireless device 400 may be an example of aspects of a UE 115 or base station 105 described with reference to FIGS. 1-3. Wireless device 400 may include a receiver 405, a flexible coding scheme module 410, and a transmitter 415. Wireless device 400 may also include a processor. Each of these components may be in communication with each other.

The receiver 405 may receive information such as packets, user data, or control information associated with various information channels (e.g., control channels, data channels, and information related to flexible coding schemes, etc.). Information may be passed on to the flexible coding scheme module 410, and to other components of wireless device 400.

The flexible coding scheme module 410 may select a coding scheme from a set of coding schemes, including a turbo coding scheme and a low density parity check (LDPC) coding scheme, available for a wireless connection, encode a message using the selected coding scheme, and transmit the encoded message over the wireless connection.

The transmitter 415 may transmit signals received from other components of wireless device 400. In some examples, the transmitter 415 may be collocated with the receiver 405 in a transceiver module. The transmitter 415 may include a single antenna, or it may include a plurality of antennas.

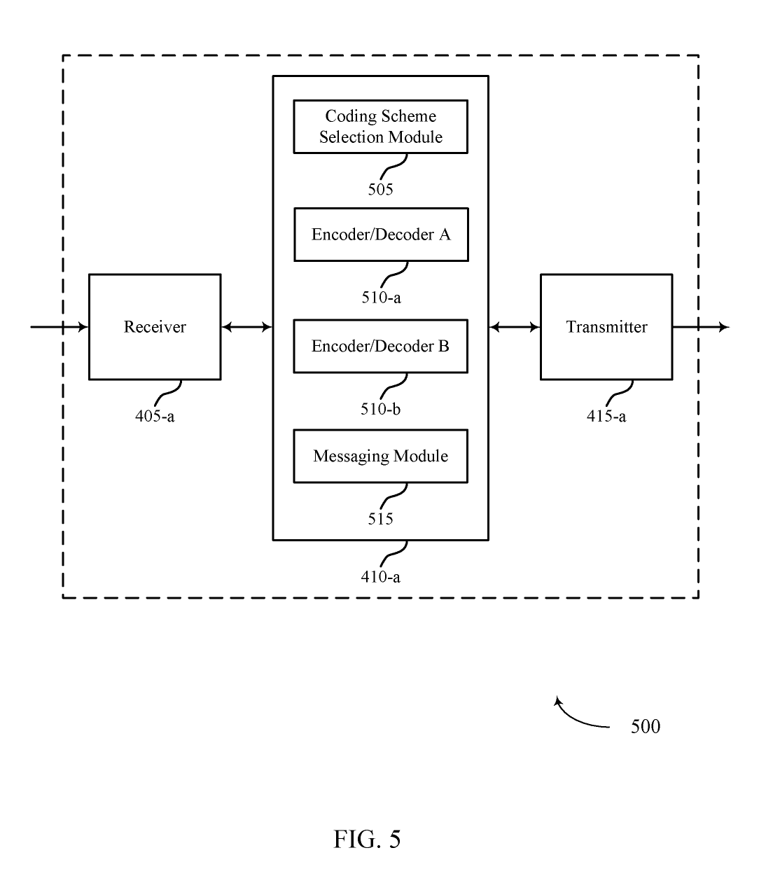

FIG. 5 shows a block diagram of a wireless device 500 for flexible coding schemes in accordance with various aspects of the present disclosure. Wireless device 500 may be an example of aspects of a wireless device 400, a UE 115 or base station 105 described with reference to FIGS. 1-4. Wireless device 500 may include a receiver 405-a, a flexible coding scheme module 410-a, or a transmitter 415-a. Wireless device 500 may also include a processor. Each of these components may be in communication with each other. The flexible coding scheme module 410-a may also include a coding scheme selection module 505, encoder/decoder 510-a and 510-b, and a messaging module 515.

The receiver 405-a may receive information which may be passed on to flexible coding scheme module 410-a, and to other components of wireless device 500. The flexible coding scheme module 410-a may perform the operations described with reference to FIG. 4. The transmitter 415-a may transmit signals received from other components of wireless device 500.

The coding scheme selection module 505 may select a coding scheme from a set of coding schemes (e.g., a set including a turbo coding scheme and a low density parity check (LDPC) coding scheme) available for a wireless connection as described with reference to FIGS. 2-3. The coding scheme selection module 505 may also determine a transmission parameter for the message and select the coding scheme based on the transmission parameter. In some examples, the transmission parameter includes a data rate, a decoding latency budget or a device capability. In some examples, the coding scheme may be selected based on the wireless connection using contention based spectrum.

The encoder/decoder 510-a or 510-b may be an example of one or more of the encoder/decoders 205-a, 205-b, 210-a, 210-b described with reference to FIG. 2. The encoder/decoder 510-a or 510-b may encode a message using the selected coding scheme as described with reference to FIGS. 2-3. The messaging module 515 may transmit the encoded message over the wireless connection as described with reference to FIGS. 2-3. The messaging module 515 may also receive a message over the wireless connection, and the encoder/decoder 510-a or 510-b may decode the message using the selected coding scheme.

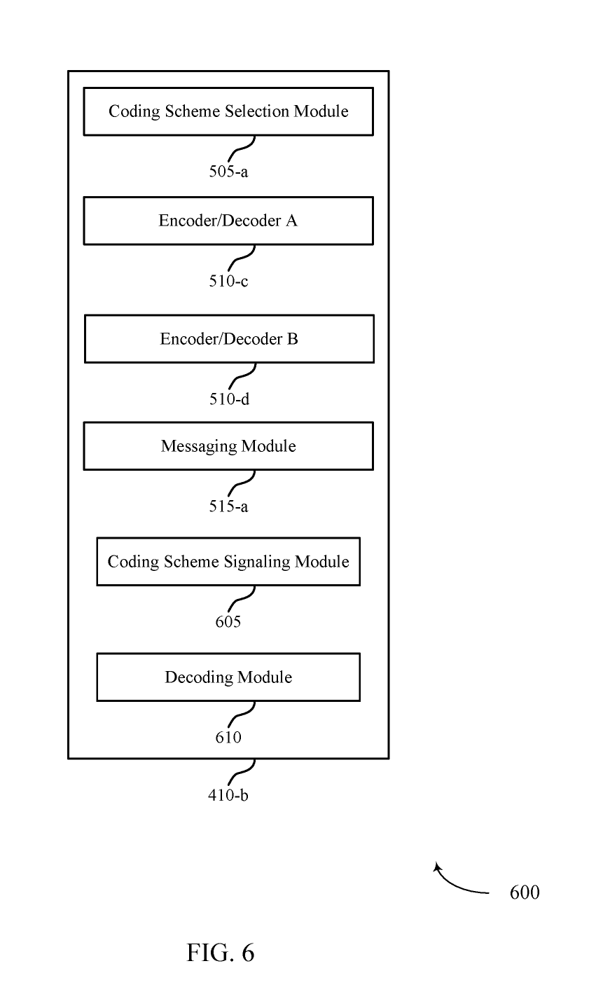

FIG. 6 shows a block diagram 600 of a flexible coding scheme module 410-b which may be a component of a wireless device 400 or a wireless device 500 for flexible coding schemes in accordance with various aspects of the present disclosure. The flexible coding scheme module 410-b may be an example of aspects of a flexible coding scheme module 410 described with reference to FIGS. 4-5. The flexible coding scheme module 410-b may include a coding scheme selection module 505-a, encoder/decoder 510-c and 510-d, and a messaging module 515-a. Each of these modules may perform the functions described with reference to FIG. 5. The flexible coding scheme module 410-b may also include a coding scheme signaling module 605.

The coding scheme signaling module 605 may transmit an indication of the coding scheme to a UE in a downlink message, receive an indication of the coding scheme from a base station in a downlink message, transmit an indication of the coding scheme to a base station in an uplink message, and receive an indication of the coding scheme from a UE in an uplink message, as described with reference to FIGS. 2-3. In some examples, the indication of the coding scheme includes a semi-static indication or a dynamic indication.

The encoder/decoder 510-c or 510-d may decode the message using the selected coding scheme as described with reference to FIGS. 2-3.

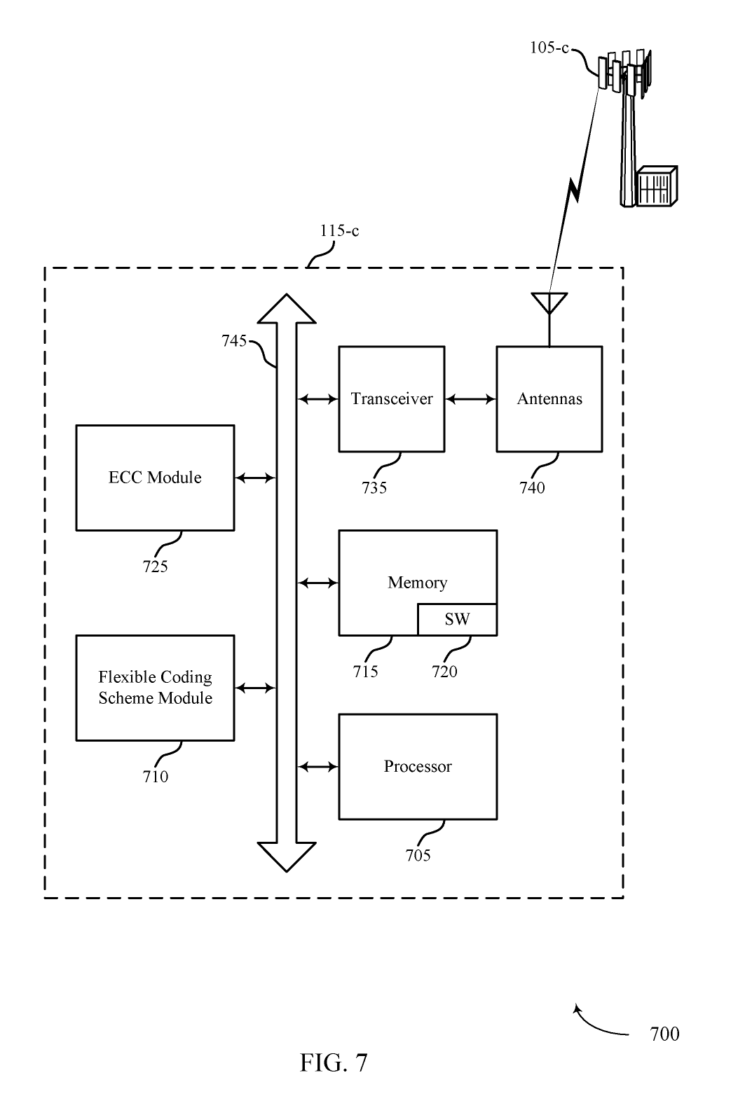

FIG. 7 shows a diagram of a system 700 configured for flexible coding schemes in accordance with various aspects of the present disclosure. System 700 may include UE 115-c and base station 105-c. UE 115-c may be an example of a wireless device 400, a wireless device 500, or a UE 115 described with reference to FIGS. 1, 2 and 4-6. UE 115-c may include a flexible coding scheme module 710, which may be an example of a flexible coding scheme module 410 described with reference to FIGS. 4-6. UE 115-c may also include an eCC module 725, which may enable eCC operations as described with reference to FIG. 1 (including operation in contention based spectrum).

UE 115-c may also include a processor 705, and memory 715 (including software (SW)) 720, a transceiver 735, and one or more antenna(s) 740, each of which may communicate, directly or indirectly, with one another (e.g., via buses 745). The transceiver 735 may communicate using the antenna(s) 740 or wired or wireless links, with one or more networks, as described above. For example, the transceiver 735 may communicate bi-directionally with base station 105-c. The transceiver 735 may include a modem to modulate the packets and provide the modulated packets to the antenna(s) 740 for transmission, and to demodulate packets received from the antenna(s) 740. While UE 115-c may include a single antenna 740, UE 115-c may also have multiple antennas 740 capable of concurrently transmitting or receiving multiple wireless transmissions.

The memory 715 may include random access memory (RAM) and read only memory (ROM). The memory 715 may store computer-readable, computer-executable software/firmware code 720 including instructions that, when executed, cause the processor 705 to perform various functions described herein (e.g., flexible coding schemes, etc.). Alternatively, the computer-executable software/firmware code 720 may not be directly executable by the processor 705 but cause a computer (e.g., when compiled and executed) to perform functions described herein. The processor 705 may include an intelligent hardware device, (e.g., a central processing unit (CPU), a microcontroller, an application specific integrated circuit (ASIC), etc.)

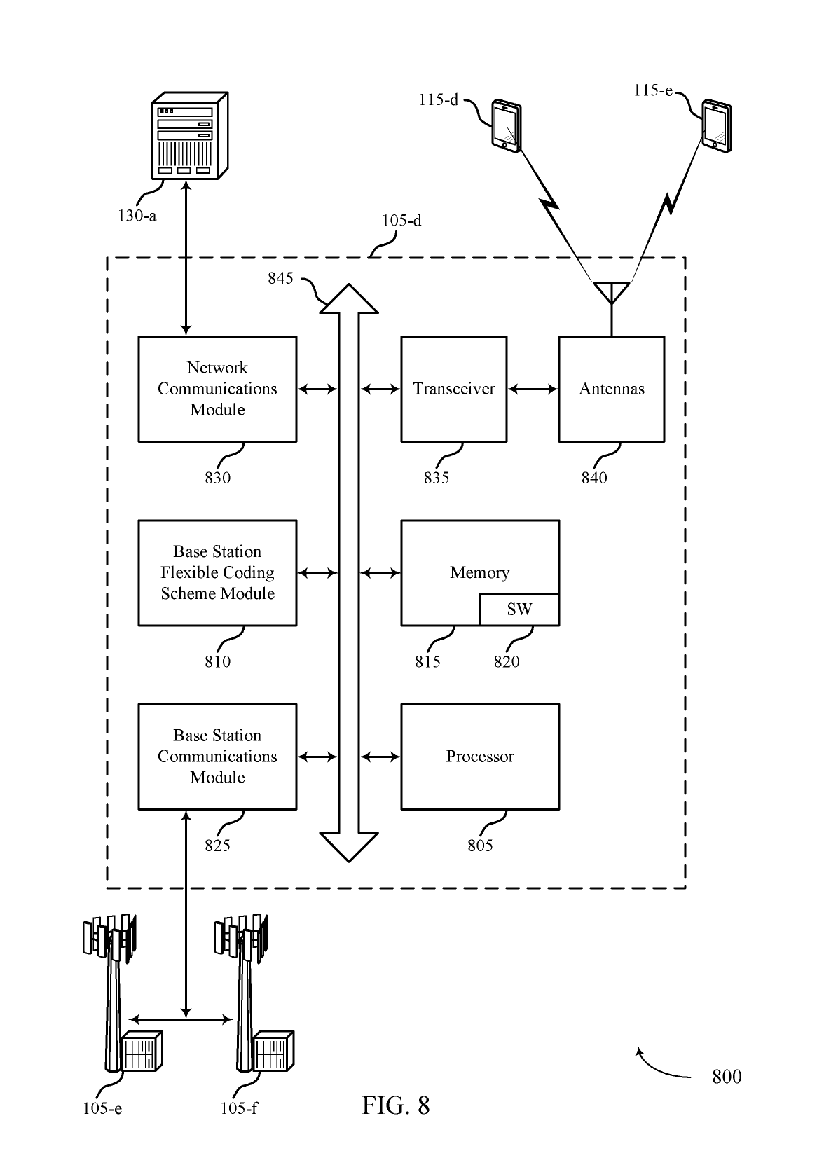

FIG. 8 shows a diagram of a system 800 including one or more base stations 105 configured for flexible coding schemes in accordance with various aspects of the present disclosure. System 800 may include base station 105-d, which may be an example of a wireless device 400, a wireless device 500, or a base station 105 described with reference to FIGS. 1, 2 and 5-7. Base Station 105-d may include a base station flexible coding scheme module 810, which may be an example of a base station flexible coding scheme module 810 described with reference to FIGS. 5-7. Base Station 105-d may also include components for bi-directional voice and data communications including components for transmitting communications and components for receiving communications. For example, base station 105-d may communicate bi-directionally with UE 115-d or UE 115-e.

In some cases, base station 105-d may have one or more wired backhaul links. Base station 105-d may have a wired backhaul link (e.g., S1 interface, etc.) to the core network 130. Base station 105-d may also communicate with other base stations 105, such as base station 105-e and base station 105-f via inter-base station backhaul links (e.g., an X2 interface). Each of the base stations 105 may communicate with UEs 115 using the same or different wireless communications technologies. In some cases, base station 105-d may communicate with other base stations such as 105-e or 105-f utilizing base station communications module 825. In some examples, base station communications module 825 may provide an X2 interface within a Long Term Evolution (LTE)/LTE-A wireless communication network technology to provide communication between some of the base stations 105. In some examples, base station 105-d may communicate with other base stations through core network 130. In some cases, base station 105-d may communicate with the core network 130 through network communications module 830.

The base station 105-d may include a processor 805, memory 815 (including software (SW)820), transceiver 835, and antenna(s) 840, which each may be in communication, directly or indirectly, with one another (e.g., over bus system 845). The transceivers 835 may be configured to communicate bi-directionally, via the antenna(s) 840, with the UEs 115, which may be multi-mode devices. The transceiver 835 (or other components of the base station 105-d) may also be configured to communicate bi-directionally, via the antennas 840, with one or more other base stations (not shown). The transceiver 835 may include a modem configured to modulate the packets and provide the modulated packets to the antennas 840 for transmission, and to demodulate packets received from the antennas 840. The base station 105-d may include multiple transceivers 835, each with one or more associated antennas 840. The transceiver may be an example of a combined receiver 405 and transmitter 415 of FIG. 4.

The memory 815 may include RAM and ROM. The memory 815 may also store computer-readable, computer-executable software code 820 containing instructions that are configured to, when executed, cause the processor 805 to perform various functions described herein (e.g., flexible coding schemes, selecting coverage enhancement techniques, call processing, database management, message routing, etc.). Alternatively, the computer-executable software code 820 may not be directly executable by the processor 805 but be configured to cause the computer, e.g., when compiled and executed, to perform functions described herein. The processor 805 may include an intelligent hardware device, e.g., a CPU, a microcontroller, an ASIC, etc. The processor 805 may include various special purpose processors such as encoders, queue processing modules, base band processors, radio head controllers, digital signal processor (DSPs), and the like.

The base station communications module 825 may manage communications with other base stations 105. In some cases, a communications management module may include a controller or scheduler for controlling communications with UEs 115 in cooperation with other base stations 105. For example, the base station communications module 825 may coordinate scheduling for transmissions to UEs 115 for various interference mitigation techniques such as beamforming or joint transmission.

The components of wireless device 400, wireless device 500, flexible coding scheme module 410, system 700 and system 800 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

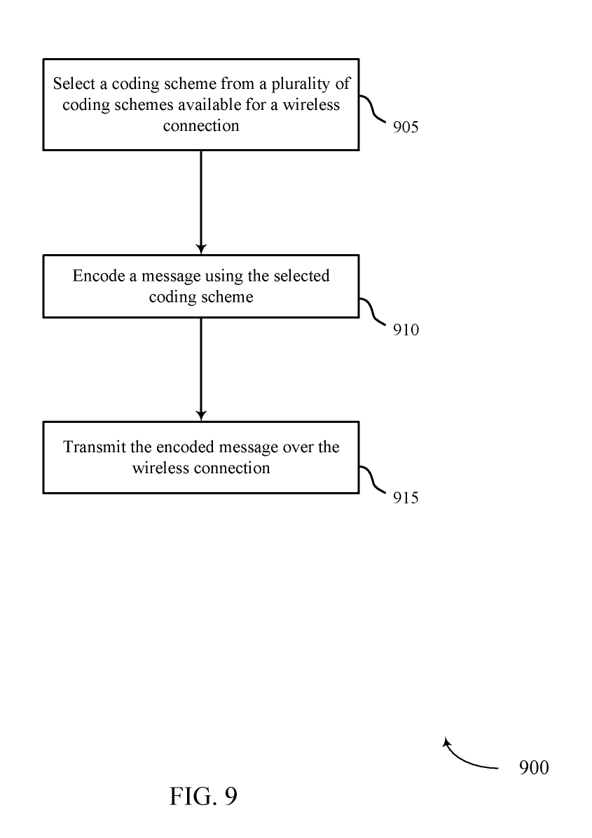

FIG. 9 shows a flowchart illustrating a method 900 for flexible coding schemes in accordance with various aspects of the present disclosure. The operations of method 900 may be implemented by a device such as a UE 115 or base station 105 or its components as described with reference to FIGS. 1-8. For example, the operations of method 900 may be performed by the flexible coding scheme module 410 as described with reference to FIGS. 4-7. In some examples, the device may execute a set of codes to control the functional elements of the device to perform the functions described below. Additionally or alternatively, the device may perform aspects the functions described below using special-purpose hardware.

At block 905, the device may select a coding scheme from a set of coding schemes available for a wireless connection, as described with reference to FIGS. 2-3. The set of available coding schemes may include a turbo coding scheme and an LDPC coding scheme. In certain examples, the operations of block 905 may be performed by the coding scheme selection module 505 as described with reference to FIG. 5.

At block 910, the device may encode a message using the selected coding scheme as described with reference to FIGS. 2-3. In certain examples, the operations of block 910 may be performed by the encoder/decoder 510-a or 510-b as described with reference to FIG. 5.

At block 915, the device may transmit the encoded message over the wireless connection as described with reference to FIGS. 2-3. In certain examples, the operations of block 915 may be performed by the messaging module 515 as described with reference to FIG. 5.

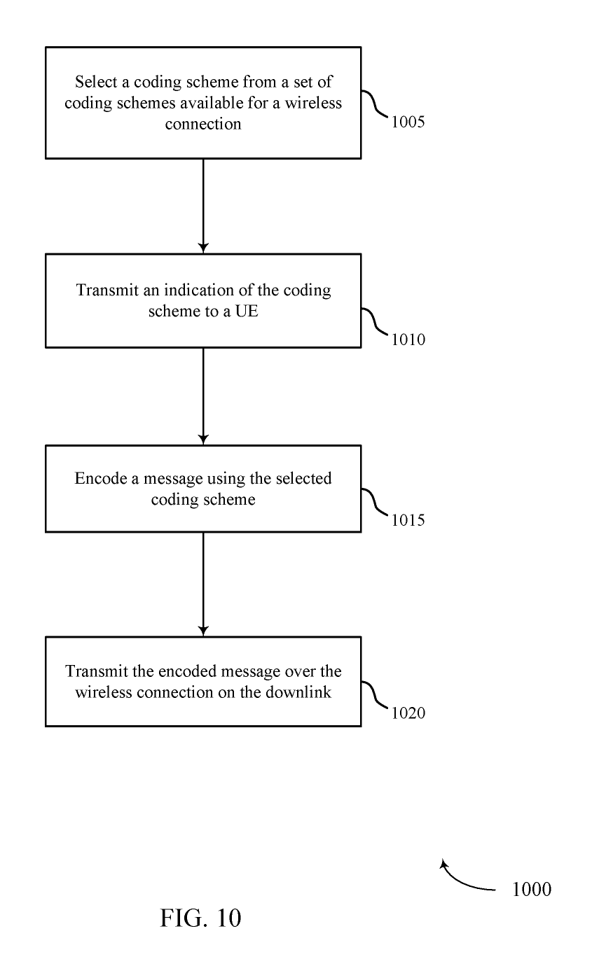

FIG. 10 shows a flowchart illustrating a method 1000 for flexible coding schemes in accordance with various aspects of the present disclosure. The operations of method 1000 may be implemented by a device such as a base station 105 or its components as described with reference to FIGS. 1-8. For example, the operations of method 1000 may be performed by the flexible coding scheme module 410 as described with reference to FIGS. 4-7. In some examples, a base station 105 may execute a set of codes to control the functional elements of the device to perform the functions described below. Additionally or alternatively, the base station 105 may perform aspects the functions described below using special-purpose hardware. The method 1000 may also incorporate aspects of method 900 of FIG. 9.

At block 1005, the base station 105 may select a coding scheme from a plurality of coding schemes available for a wireless connection as described with reference to FIGS. 2-3. The plurality of coding schemes may comprise at least a turbo coding scheme and an LDPC coding scheme. In certain examples, the operations of block 1005 may be performed by the coding scheme selection module 505 as described with reference to FIG. 5.

At block 1010, the base station 105 may transmit an indication of the coding scheme to a UE, wherein the message is a downlink message as described with reference to FIGS. 2-3. In certain examples, the operations of block 1010 may be performed by the coding scheme signaling module 605 as described with reference to FIG. 6.

At block 1015, the base station 105 may encode a message using the selected coding scheme as described with reference to FIGS. 2-3. In certain examples, the operations of block 1015 may be performed by the encoder/decoder 510-a or 510-b as described with reference to FIG. 5.

At block 1020, the base station 105 may transmit the encoded message over the wireless connection as described with reference to FIGS. 2-3. In certain examples, the operations of block 1020 may be performed by the messaging module 515 as described with reference to FIG. 5.

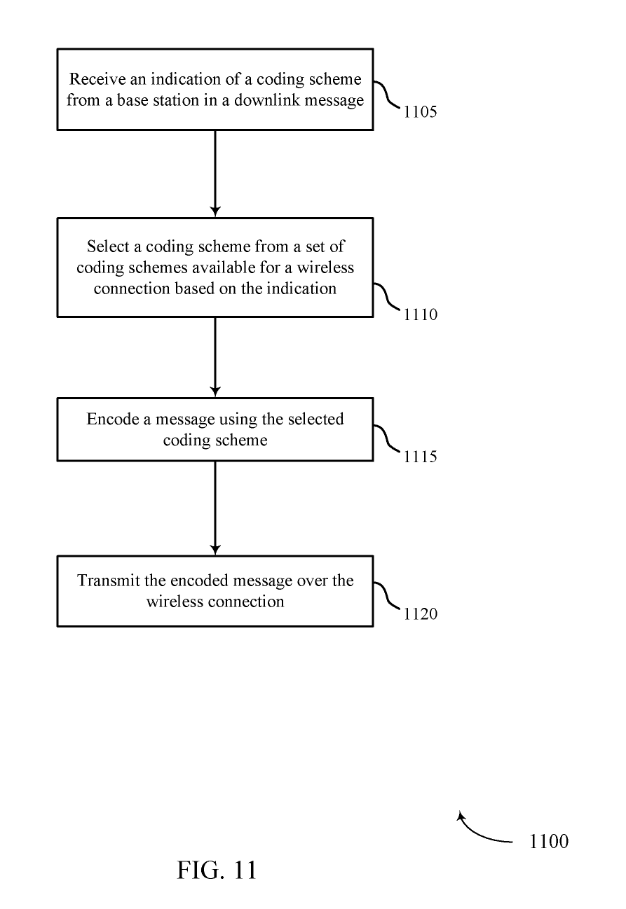

FIG. 11 shows a flowchart illustrating a method 1100 for flexible coding schemes in accordance with various aspects of the present disclosure. The operations of method 1100 may be implemented by a UE 115 or its components as described with reference to FIGS. 1-8. For example, the operations of method 1100 may be performed by the flexible coding scheme module 410 as described with reference to FIGS. 4-7. In some examples, a UE 115 may execute a set of codes to control the functional elements of the UE 115 to perform the functions described below. Additionally or alternatively, the UE 115 may perform aspects the functions described below using special-purpose hardware. The method 1100 may also incorporate aspects of methods 900, and 1000 of FIGS. 9-10.

At block 1105, the UE 115 may receive an indication of the coding scheme from a base station in a downlink message as described with reference to FIGS. 2-3. In certain examples, the operations of block 1105 may be performed by the coding scheme signaling module 605 as described with reference to FIG. 6.

At block 1110, the UE 115 may select a coding scheme from a set of coding schemes available for a wireless connection based on the indication, as described with reference to FIGS. 2-3. The set of coding schemes may include a turbo coding scheme and an LDPC coding scheme. In certain examples, the operations of block 1110 may be performed by the coding scheme selection module 505 as described with reference to FIG. 5.

At block 1115, the UE 115 may encode a message using the selected coding scheme as described with reference to FIGS. 2-3. In certain examples, the operations of block 1115 may be performed by the encoder/decoder 510-a or 510-b as described with reference to FIG. 5.

At block 1120, the UE 115 may transmit the encoded message over the wireless connection as described with reference to FIGS. 2-3. In certain examples, the operations of block 1120 may be performed by the messaging module 515 as described with reference to FIG. 5.

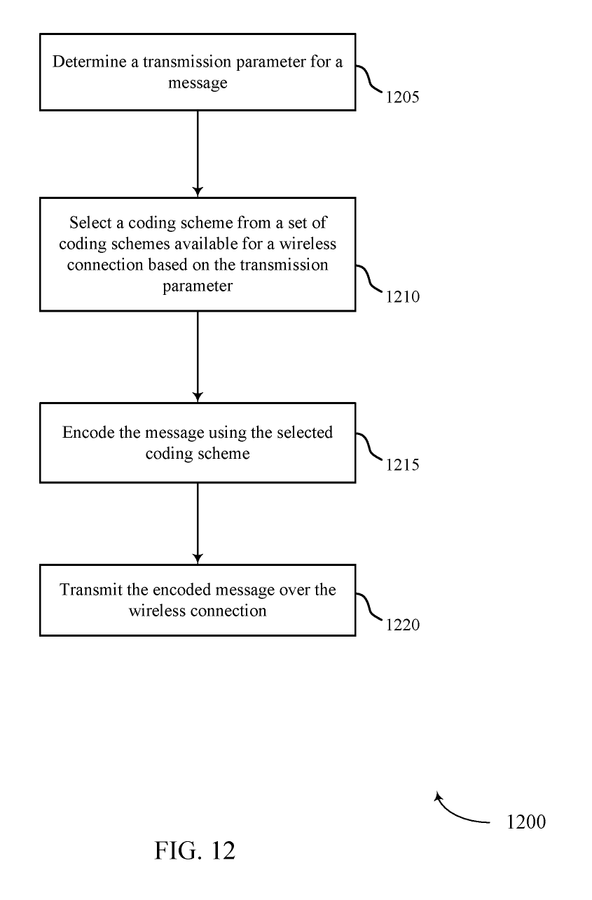

FIG. 12 shows a flowchart illustrating a method 1200 for flexible coding schemes in accordance with various aspects of the present disclosure. The operations of method 1200 may be implemented by a device such as a UE 115 or base station 105 or its components as described with reference to FIGS. 1-8. For example, the operations of method 1200 may be performed by the flexible coding scheme module 410 as described with reference to FIGS. 4-7. In some examples, a device may execute a set of codes to control the functional elements of the device to perform the functions described below. Additionally or alternatively, the device may perform aspects the functions described below using special-purpose hardware. The method 1200 may also incorporate aspects of methods 900, 1000, and 1100 of FIGS. 9-11.

At block 1205, the device may determine a transmission parameter for a message as described with reference to FIGS. 2-3. In certain examples, the operations of block 1205 may be performed by the coding scheme selection module 505 as described with reference to FIG. 5.

At block 1210, the device may select a coding scheme from a set of coding schemes available for a wireless connection based on the transmission parameter as described with reference to FIGS. 2-3. The set of coding schemes may include a turbo coding scheme and an LDPC coding scheme. In certain examples, the operations of block 1210 may be performed by the coding scheme selection module 505 as described with reference to FIG. 5.

At block 1215, the device may encode the message using the selected coding scheme as described with reference to FIGS. 2-3. In certain examples, the operations of block 1215 may be performed by the encoder/decoder 510-a or 510-b as described with reference to FIG. 5.

At block 1220, the device may transmit the encoded message over the wireless connection as described with reference to FIGS. 2-3. In certain examples, the operations of block 1220 may be performed by the messaging module 515 as described with reference to FIG. 5.

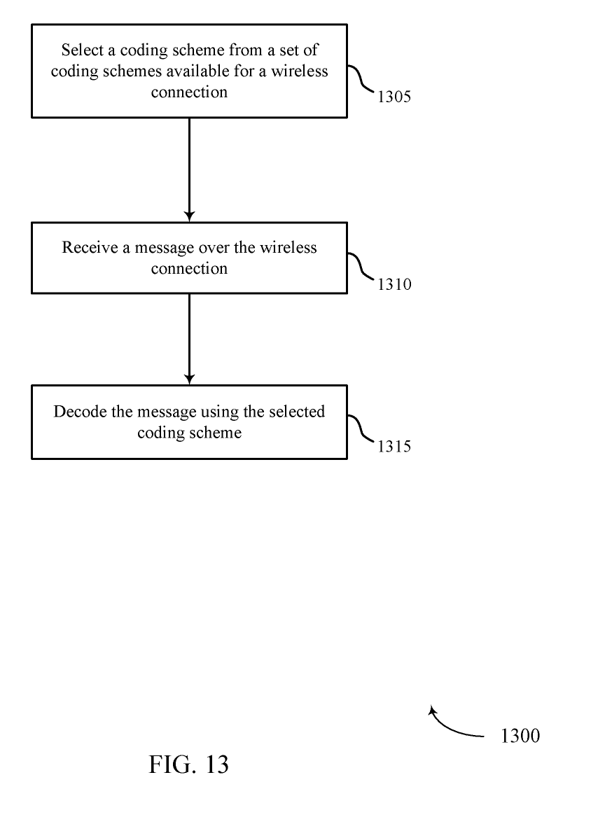

FIG. 13 shows a flowchart illustrating a method 1300 for flexible coding schemes in accordance with various aspects of the present disclosure. The operations of method 1300 may be implemented by a UE 115 or a base station 105 or its components as described with reference to FIGS. 1-8. For example, the operations of method 1300 may be performed by the flexible coding scheme module 410 as described with reference to FIGS. 4-7. In some examples, a device may execute a set of codes to control the functional elements of the device to perform the functions described below. Additionally or alternatively, the device may perform aspects the functions described below using special-purpose hardware. The method 1300 may also incorporate aspects of methods 900, 1000, 1100, and 1200 of FIGS. 9-12.

At block 1305, the device may select a coding scheme from a set of coding schemes available for a wireless connection, as described with reference to FIGS. 2-3. The set of coding schemes may include a turbo coding scheme and a low density parity check (LDPC) coding scheme. In certain examples, the operations of block 1305 may be performed by the coding scheme selection module 505 as described with reference to FIG. 5.

At block 1310, the device may receive a message over the wireless connection as described with reference to FIGS. 2-3. In certain examples, the operations of block 1310 may be performed by the messaging module 515 as described with reference to FIG. 5.

At block 1315, the device may decode the message using the selected coding scheme as described with reference to FIGS. 2-3. In certain examples, the operations of block 1315 may be performed by the encoder/decoder 510-a or 510-b as described with reference to FIG. 5.

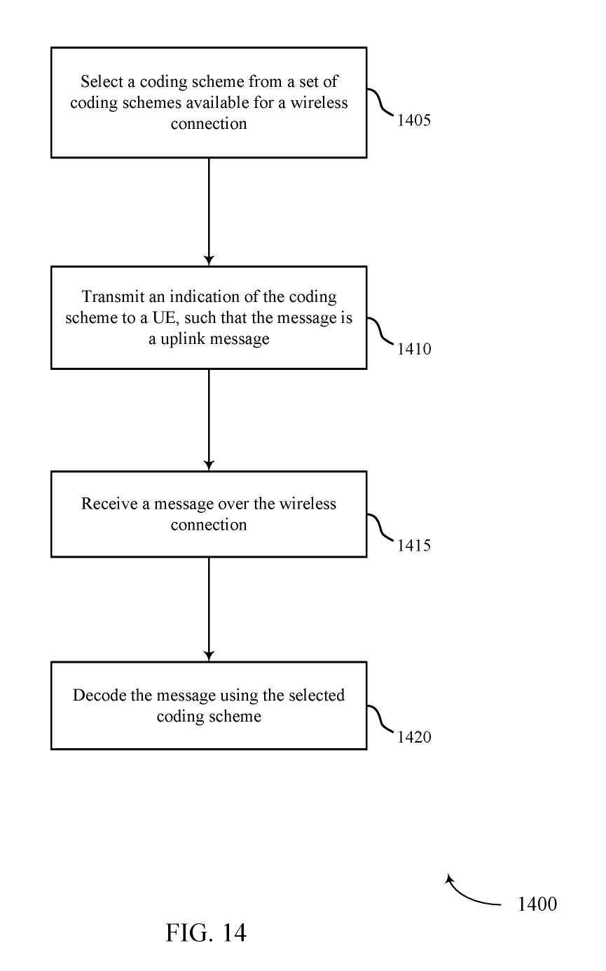

FIG. 14 shows a flowchart illustrating a method 1400 for flexible coding schemes in accordance with various aspects of the present disclosure. The operations of method 1400 may be implemented by a base station 105 or its components as described with reference to FIGS. 1-8. For example, the operations of method 1400 may be performed by the flexible coding scheme module 410 as described with reference to FIGS. 4-7. In some examples, a base station 105 may execute a set of codes to control the functional elements of the base station 105 to perform the functions described below. Additionally or alternatively, the base station 105 may perform aspects the functions described below using special-purpose hardware. The method 1400 may also incorporate aspects of methods 900, 1000, 1100, 1200, and 1300 of FIGS. 9-13.

At block 1405, the base station 105 may select a coding scheme from a plurality of coding schemes available for a connection as described with reference to FIGS. 2-3. The set of coding schemes may include a turbo coding scheme and an LDPC coding scheme. In certain examples, the operations of block 1405 may be performed by the coding scheme selection module 505 as described with reference to FIG. 5.

At block 1410, the base station 105 may transmit an indication of the coding scheme to a UE, wherein the coding scheme is to be applied by the UE for an uplink message as described with reference to FIGS. 2-3. In certain examples, the operations of block 1410 may be performed by the coding scheme signaling module 605 as described with reference to FIG. 6.

At block 1415, the base station 105 may receive a message over the wireless connection as described with reference to FIGS. 2-3. In certain examples, the operations of block 1415 may be performed by the messaging module 515 as described with reference to FIG. 5.

At block 1420, the base station 105 may decode the message using the selected coding scheme as described with reference to FIGS. 2-3. In certain examples, the operations of block 1420 may be performed by the encoder/decoder 510-a or 510-b as described with reference to FIG. 5.

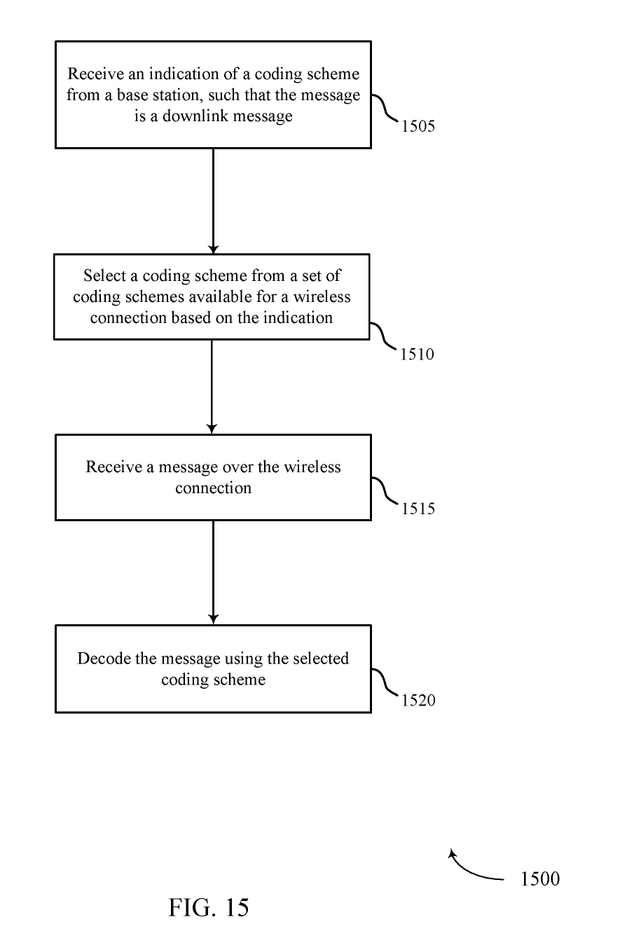

FIG. 15 shows a flowchart illustrating a method 1500 for flexible coding schemes in accordance with various aspects of the present disclosure. The operations of method 1500 may be implemented by a UE 115 or its components as described with reference to FIGS. 1-8. For example, the operations of method 1500 may be performed by the flexible coding scheme module 410 as described with reference to FIGS. 4-7. In some examples, a UE 115 may execute a set of codes to control the functional elements of the UE 115 to perform the functions described below. Additionally or alternatively, the UE 115 may perform aspects the functions described below using special-purpose hardware. The method 1500 may also incorporate aspects of methods 900, 1000, 1100, 1200, 1300, and 1400 of FIGS. 9-14.

At block 1505, the UE 115 may receive an indication of the coding scheme from a base station, wherein the message is a downlink message as described with reference to FIGS. 2-3. In certain examples, the operations of block 1505 may be performed by the coding scheme signaling module 605 as described with reference to FIG. 6.

At block 1510, the UE 115 may select a coding scheme from a plurality of coding schemes available for a connection as described with reference to FIGS. 2-3. The plurality of coding schemes may include at least a turbo coding scheme and an LDPC coding scheme. In certain examples, the operations of block 1510 may be performed by the coding scheme selection module 505 as described with reference to FIG. 5.

At block 1515, the UE 115 may receive a message over the wireless connection as described with reference to FIGS. 2-3. In certain examples, the operations of block 1515 may be performed by the messaging module 515 as described with reference to FIG. 5.

At block 1520, the UE 115 may decode the message using the selected coding scheme as described with reference to FIGS. 2-3. In certain examples, the operations of block 1520 may be performed by the encoder/decoder 510-a or 510-b as described with reference to FIG. 5.

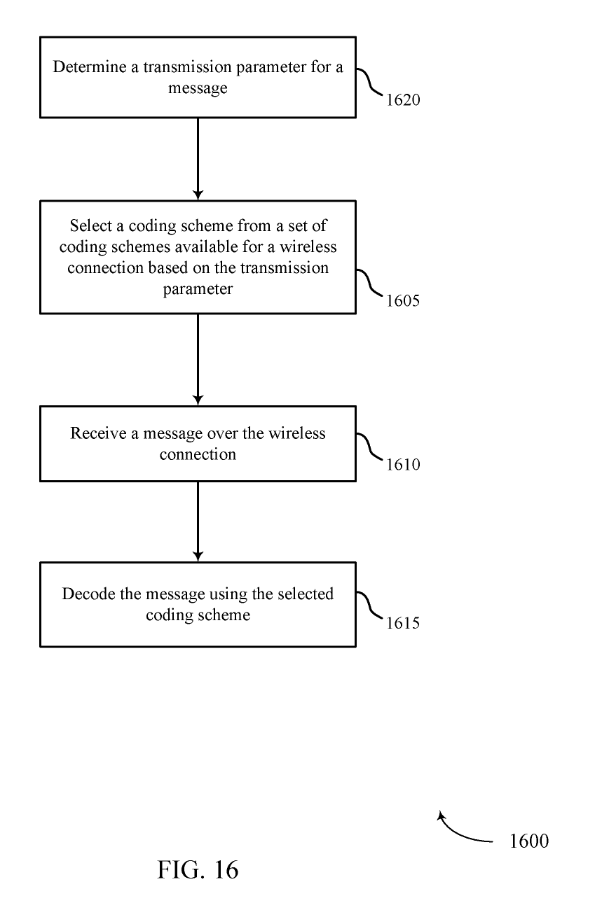

FIG. 16 shows a flowchart illustrating a method 1600 for flexible coding schemes in accordance with various aspects of the present disclosure. The operations of method 1600 may be implemented by a device such as a UE 115 or base station 105 or its components as described with reference to FIGS. 1-8. For example, the operations of method 1600 may be performed by the flexible coding scheme module 410 as described with reference to FIGS. 4-7. In some examples, a device may execute a set of codes to control the functional elements of the device to perform the functions described below. Additionally or alternatively, the device may perform aspects the functions described below using special-purpose hardware. The method 1600 may also incorporate aspects of methods 900, 1000, 1100, 1200, 1300, 1400, and 1500 of FIGS. 9-15.

At block 1605, the device may determine a transmission parameter for a message as described with reference to FIGS. 2-3. In certain examples, the operations of block 1605 may be performed by the coding scheme selection module 505 as described with reference to FIG. 5.

At block 1610, the device may select a coding scheme from a set of coding schemes available for a connection based on the transmission parameter as described with reference to FIGS. 2-3. The plurality of coding schemes may include at least a turbo coding scheme and an LDPC coding scheme. In certain examples, the operations of block 1610 may be performed by the coding scheme selection module 505 as described with reference to FIG. 5.

At block 1615, the device may receive a message over the wireless connection as described with reference to FIGS. 2-3. In certain examples, the operations of block 1615 may be performed by the messaging module 515 as described with reference to FIG. 5.

At block 1620, the device may decode the message using the selected coding scheme as described with reference to FIGS. 2-3. In certain examples, the operations of block 1620 may be performed by the encoder/decoder 510-a or 510-b as described with reference to FIG. 5.

Thus, methods 900, 1000, 1100, 1200, 1300, 1400, 1500, and 1600 may provide for flexible coding schemes. It should be noted that methods 900, 1000, 1100, 1200, 1300, 1400, 1500, and 1600 describe possible implementation, and that the operations and the steps may be rearranged or otherwise modified such that other implementations are possible. In some examples, aspects from two or more of the methods 900, 1000, 1100, 1200, 1300, 1400, 1500, and 1600 may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-advanced (LTE-a) are new releases of Universal Mobile Telecommunications System (UMTS) that use E-UTRA. UTRA, E-UTRA, Universal Mobile Telecommunications System (UMTS), LTE, LTE-a, and Global System for Mobile communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-a networks, including such networks described herein, the term evolved node B (eNB) may be generally used to describe the base stations. The wireless communications system or systems described herein may include a heterogeneous LTE/LTE-a network in which different types of evolved node B (eNBs) provide coverage for various geographical regions. For example, each eNB or base station may provide communication coverage for a macro cell, a small cell, or other types of cell. The term “cell” is a 3 GPP term that can be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), Home NodeB, a Home eNodeB, or some other suitable terminology. The geographic coverage area for a base station may be divided into sectors making up a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bidirectional communications using frequency division duplex (FDD) (e.g., using paired spectrum resources) or time division duplex (TDD) operation (e.g., using unpaired spectrum resources). Frame structures may be defined for frequency division duplex (FDD) (e.g., frame structure type 1) and TDD (e.g., frame structure type 2).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can include RANI, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication, comprising:
determining a transmission parameter for a message to be encoded and transmitted;
selecting a coding scheme from a plurality of coding schemes available for a wireless connection based at least in part on the transmission parameter;
encoding the message using the selected coding scheme; and
transmitting the encoded message over the wireless connection.

2. The method of claim 1, further comprising:
transmitting an indication of the coding scheme to a user equipment (UE), wherein the encoded message is a downlink message.

3. The method of claim 2, wherein the indication of the coding scheme comprises a semi-static indication or a dynamic indication.

4. The method of claim 1, further comprising:
receiving an indication of the coding scheme from a base station, wherein the message is an uplink message.

5. The method of claim 4, wherein the indication of the coding scheme comprises a semi-static indication or a dynamic indication.

6. The method of claim 1, wherein the transmission parameter comprises a data rate, a decoding latency budget or a device capability, or a combination thereof.

7. The method of claim 1, wherein the coding scheme is selected based at least in part on the wireless connection using a contention based spectrum.

8. The method of claim 1, wherein the plurality of coding schemes comprises at least a turbo coding scheme and a low density parity check coding scheme.

9. The method of claim 8, wherein the selected coding scheme comprises the turbo coding scheme for a first portion of a transmission time interval and the low density parity check coding scheme for a second portion of the transmission time interval.

10. A method of wireless communication, comprising:
determining a transmission parameter for a message;
selecting a coding scheme from a plurality of coding schemes available for a wireless connection based at least in part on the transmission parameter;
receiving the message over the wireless connection; and
decoding the message using the selected coding scheme.

11. The method of claim 10, further comprising:
transmitting an indication of the coding scheme to a user equipment (UE), wherein the message is an uplink message and the indication of the coding scheme comprises a semi-static indication or a dynamic indication.

12. The method of claim 10, further comprising:
receiving an indication of the coding scheme from a base station, wherein the message is a downlink message and the indication of the coding scheme comprises a semi-static indication or a dynamic indication.

13. The method of claim 10, wherein the transmission parameter comprises a data rate, a decoding latency budget, or a device capability, or a combination thereof.

14. The method of claim 10, wherein the coding scheme is selected based at least in part on the wireless connection using contention based spectrum.

15. The method of claim 10, wherein the selected coding scheme comprises at least a turbo coding scheme and a low density parity check coding scheme.

16. The method of claim 15, wherein the selected coding scheme comprises the turbo coding scheme for a first portion of a transmission time interval and the low density parity check coding scheme for a second portion of the transmission time interval.

17. An apparatus for wireless communication, comprising:
a processor; and
memory, in electronic communication with the processor, storing instructions that, when executed by the processor, cause the apparatus at least to:
determine a transmission parameter for a message to be encoded and transmitted;
select a coding scheme from a plurality of coding schemes available for a wireless connection based at least in part on the transmission parameter;
encode the message using the selected coding scheme; and
transmit the encoded message over the wireless connection.

18. The apparatus of claim 17, wherein the instructions, when executed by the processor, cause the apparatus to:
transmit an indication of the coding scheme to a UE, wherein the encoded message is a downlink message and the indication of the coding scheme comprises a semi-static indication or a dynamic indication.

19. The apparatus of claim 17, wherein the instructions, when executed by the processor, cause the apparatus to:
receive an indication of the coding scheme from a base station, wherein the message is an uplink message and the indication of the coding scheme comprises a semi-static indication or a dynamic indication.

20. The apparatus of claim 17, wherein the transmission parameter comprises a data rate, a decoding latency budget, a device capability, or a combination thereof.

21. The apparatus of claim 17, wherein the coding scheme is selected based at least in part on the wireless connection using a contention based spectrum.

22. The apparatus of claim 17, wherein the plurality of coding schemes comprises at least a turbo coding scheme and a low density parity check coding scheme.

23. The apparatus of claim 22, wherein the selected coding scheme comprises the turbo coding scheme for a first portion of a transmission time interval and the low density parity check coding scheme for a second portion of the transmission time interval.

24. An apparatus for wireless communication, comprising:
a processor; and
memory, in electronic communication with the processor, storing instructions that, when executed by the processor, cause the apparatus at least to:
determine a transmission parameter for a message;
select a coding scheme from a plurality of coding schemes available for a wireless connection based at least in part on the transmission parameter;
receive a message over the wireless connection; and
decode the message using the selected coding scheme.

25. The apparatus of claim 24, wherein the instructions, when executed by the processor, cause the apparatus to:
transmit an indication of the coding scheme to a user equipment, wherein the message is an uplink message and the indication of the coding scheme comprises a semi-static indication or a dynamic indication.

26. The apparatus of claim 24, wherein the instructions, when executed by the processor, cause the apparatus to:
receive an indication of the coding scheme from a base station, wherein the message is a downlink message and the indication of the coding scheme comprises a semi-static indication or a dynamic indication.

27. The apparatus of claim 24, wherein the transmission parameter comprises a data rate, a decoding latency budget, a device capability, or a combination thereof.

28. The apparatus of claim 24, wherein the coding scheme is selected based at least in part on the wireless connection using contention based spectrum.

29. The apparatus of claim 24, wherein the plurality of coding schemes comprises at least a turbo coding scheme and a low density parity check coding scheme.

30. The apparatus of claim 29, wherein the selected coding scheme comprises the turbo coding scheme for a first portion of a transmission time interval and the low density parity check coding scheme for a second portion of the transmission time interval.
